(19) United States
(12) Patent Application Publication
(10) Pub. No.: US 2011/0109025 A1
(43) Pub. Date: May 12, 2011

(54) APPARATUS AND METHOD FOR ELIMINATING AND PREVENTING AUDIBLE VIBRATION IN HIGH RISE RAILINGS

(76) Inventor: Kim Sechler, Tavares, FL (US)

(21) Appl. No.: 12/615,178

(22) Filed: Nov. 9, 2009

(51) Int. Cl. F16F 7/00; E04H 17/16

(52) U.S. Cl. 267/136; 256/22

(57) ABSTRACT

A simple and cost-effective vibration-reduction system, adapted for easy application to and/or retrofit of essentially any picket-style railing, wherein each of a plurality of support members is positioned along a wire, wherein each support member is frictionally secured to a picket, and wherein each support member is adapted to allow for tensioned adjustment of the wire relative thereto, such that the wire may be adjustably positioned across the picket span to relate the pickets at a desired tension, effectively decreasing picket vibration and realized decibels without impacting the structural integrity of the pickets and with minimal impact on view, thereby maximizing functionality and aesthetic appearance.

### FIELD

The present disclosure relates generally to structural railings, and more particularly, to an apparatus and method for eliminating and/or preventing audible vibration in high rise railings, and particularly in aluminum high rise railings.

### BACKGROUND

Any raised structure with accessible exterior features necessarily requires appropriate safety elements to prevent accidental falls. Effective safety elements may include, for example, partial height walls, partial or full height chain link or other fencing, railings, or the like. The selection of materials and structural configuration is typically founded upon the level of danger presented by the risk of fall, with greater height balconies necessitating the most sturdy and protective elements. Another factor relevant to the selection of structure and materials for such exterior features is the cost of materials and installation relative to the value of the structure. Still a further factor is aesthetics, wherein owners of balconies and decks intended to be utilized for enjoyment of a view prefer protective barriers with a minimal impact or imposition thereon.

In general, a partial height steel and concrete barrier wall may be considered amongst, if not the most strong. Unfortunately, however, solid or partially solid walls disadvantageously prevent any viewing therethrough. Moreover, such heavy exterior structural elements can increase construction costs for the entire building, wherein distribution of weight stress and strain must be accomplished. Alternatively, a partial or full height chain link or other mesh-like fence may also function as a strong safety feature, albeit with an aesthetic disadvantage, extensively interrupting the view with generally industrial design elements. Another option is a PLEXIGLAS or LEXAN wall with suitable railing. These clear view barriers offer a minimally intrusive physical barricade, but can be prohibitively expensive to many installations. Additionally, frequent and potentially dangerous cleaning is required in order to maintain the clear view. Therefore, the most common balance of features selected to allow for safety, strength, minimized weight requirements, expense, and maximized view is a rail and picket configuration, formed from aluminum and steel components.

In such a rail and picket structure, especially with narrow or small diameter pickets, impedance of view is generally minimized, with open spaces extending the full height between each picket. Unfortunately, however, for some installations subject to high winds, such as high rise buildings and cruise ships, for example, wind-generated movement or vibration of the pickets may cause audible sounds, or humming. Devices have been presented in an effort to eliminate such undesirable noise. Each, however, is disadvantageous in view of the present disclosure.

One type of device incorporates acoustic panels into the rail and picket structure. Such acoustic panels function to absorb sound waves, and may thus serve to decrease the sound waves actually emanating from the source; however, such panels are necessarily solid and disadvantageously obstruct viewing. Another approach to preventing vibration involves constructing a handrail with a vertical sealing plate centrally positioned on the pickets in order to prevent the passage of air therethrough. Such a device disadvantageously limits potentially enjoyable air flow, or breeze. Still other efforts have been directed toward affixing structural reinforcement rails across the pickets in order to impact the flow of air therebetween. These strategies seek to disrupt Karman vortex, adding weighted mass to shift the response of the handrail structure, and typically require structural intrusion into the picket, such as for entry of a fastening bolt, wherein corrosion may subsequently foster, especially in oceanfront applications. Each is also disadvantageous in view of the present device in that each not only introduces further structural rails into the potential view space, but may still allow for vibratory movement of a picket body according to the fixed position of the structural rails. Still another strategy focuses on the installation of a secondary set of reinforcing pickets, spaced apart from a primary set of pickets, wherein the second set of pickets may dampen waves emanating from the primary set pickets. Such an approach is disadvantageously complex in view of the present disclosure.

Therefore, it is readily apparent that there is a need for a device that is particularly suited for use on a high-rise railing, that can effectively eliminate vibration of the pickets, that is aesthetically and structurally of minimal impact relative to the overall railing structure, that is cost-effective, and that is adjustably adaptive and easy to retroactively install, thereby avoiding the above-discussed disadvantages.

### BRIEF SUMMARY

Briefly described, in a preferred embodiment, the present apparatus and method overcomes the above-mentioned disadvantages and meets the recognized need for such a device by providing a crosswire, tensively connected between the internal pickets of a railing.

According to its major aspects and broadly stated, in its preferred form, the present device is a simple and cost-effective vibration-reduction system, adapted for easy application to and/or retrofit of essentially any picket-style railing, wherein each of a plurality of support members is positioned along a wire, wherein each support member is frictionally secured to a picket, and wherein each support member is adapted to allow for tensioned adjustment of the wire relative thereto, such that the wire may be adjustably positioned across the picket span to relate the pickets at a desired tension, effectively decreasing picket vibration and realized decibels without impacting the structural integrity of the pickets and with minimal impact on view, thereby maximizing functionality and aesthetic appearance.

More specifically, the apparatus of the present disclosure preferably comprises a cable, a plurality of brackets, and a plurality of tension applicators. According to the preferred form, each bracket is adapted for frictional engagement about the diameter of a picket, is provided with a throughhole for allowing installation on the cable, and is further adapted with a tension-adjustment port for receipt of a tension applicator. According to the preferred method for preventing audible vibration of a high rise railing, and particularly an aluminum high rise railing, a plurality of brackets are slidably installed along a length of cable, wherein the number of brackets is selected according to the number of pickets in a railing section. A tension applicator is inserted into each tension-adjustment port of each bracket, and the first bracket is fit into place approximately midway along the height of the first internal picket adjacent the baluster. Thereafter, a second bracket is similarly positioned on the second internal picket, and so on, until each picket in series is adapted with a bracket and ending at the last internal picket adjacent the opposing baluster of the railing segment. Finally, the tension of the cable spanning across the pickets is selectively adjusted via rotation of the tension applicators in each bracket. In such manner, picket vibrations are immediately arrested. Additionally, should environmental factors or structural changes impact the railing, further and selective tension adjustment may be accomplished in order to maintain maximized system effectiveness.

Thus, a feature and advantage of the present apparatus and method is its ability to perform as a cost-effective unit, suitable for deployment on essentially any picket-style railing, and particularly on aluminum pickets having a square or round cross-sectional shape.

Another feature and advantage of the present apparatus and method is its ability to effectively quiet undesirable humming of high rise railings.

Another feature and advantage of the present apparatus and method is its ability to perform as a customized accessory by incorporation of movable brackets, capable of adapting to any picket span.

Yet another feature and advantage of the present apparatus and method is its ability to provide effective vibration dampening and decibel reduction without sacrificing view.

Still another feature and advantage of the present apparatus and method is its easy retrofit installation to existing railings.

Yet still another feature and advantage of the present apparatus and method is its ability for effective installation without impact on the structural integrity of the pickets.

Still yet another feature and advantage of the present apparatus is its ability to be cost-effectively shipped, according to its lightweight nature and compactable structure.

Yet another feature and advantage of the present apparatus and method is its ability to tensively relate a plurality of pickets.

Still another feature and advantage of the present method is its ability to be accomplished without complicated training.

Yet another feature and advantage of the present apparatus and method is its ability to remain essentially unnoticeable when viewed at a distance.

These and other features and advantages of the invention will become more apparent to one skilled in the art from the following description and claims when read in light of the accompanying drawings.

### BRIEF DESCRIPTION OF THE DRAWINGS

The present disclosure will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of an apparatus for preventing and eliminating audible vibration, according to the preferred embodiment of the present device, showing the apparatus installed on a railing workpiece;

FIG. 2 is a partial, perspective view of the apparatus of FIG. 1, showing a bracket installed on a picket, and with a tensioned cable extending therebetween;

FIG. 3 is a perspective view of the apparatus of FIG. 1, showing the apparatus assembled prior to installation, and an installation tool;

FIG. 4A is a top, cross-sectional view of a bracket, according to the preferred embodiment of the present disclosure;

FIG. 4B is an end view of a bracket, according to the preferred embodiment of the present disclosure;

FIG. 4C is a top, cross-sectional view of a bracket, according to an alternate embodiment of the present disclosure;

FIG. 5 is a graphical display of acceleration measurement results before installation of apparatus 10;

FIG. 6 is a graphical display of acceleration measurement results after installation of apparatus 10;

FIG. 7 is a graphical display of vibratory decibel measurement results before installation of apparatus 10; and,

FIG. 8 is a graphical display of vibratory decibel measurement results after installation of apparatus 10.

### DETAILED DESCRIPTION OF THE PREFERRED AND ALTERNATE EMBODIMENTS

In describing the preferred and alternate embodiments of the present disclosure, as illustrated in the figures and/or described herein, specific terminology is employed for the sake of clarity. The disclosure, however, is not intended to be limited to the specific terminology so selected, and it is to be understood that each specific element includes all technical equivalents that operate in a similar manner to accomplish similar functions.

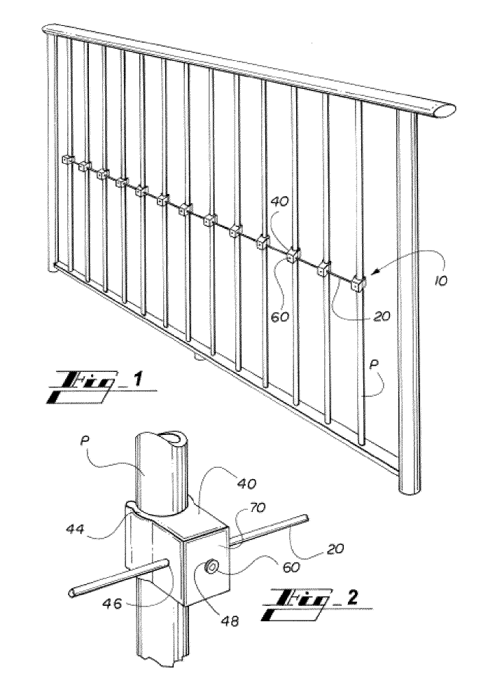

Referring now to FIGS. 1-8, anti-vibratory apparatus 10 preferably comprises cable 20, plurality of attachment components 40, and plurality of tension applicators 60, wherein anti-vibratory apparatus 10 is preferably utilized for eliminating and/or preventing audible vibration and resonation in high rise railings, such as “humming” caused from wind tunnels, air vortexes and the like.

That is, sounds, or compression waves, can be generated by vibrating pickets, much like the vibratory mechanism of vocal cord sound generation. Wind can act as the initial energy input to set off free vibration. The air passing through or by the pickets can be made to vibrate as sound waves. The frequencies, or sounds, are detected when the waves contact and vibrate the ear drum, with the amplitude of the sound wave perceived as its loudness. Audio frequency sound is that audible to human ears, typically between 12 hertz and 20 kilohertz.

Each picket is a finite element with structural dimensions, mass and stiffness defining natural frequencies. Vibration thereof may be analogously compared to strings under tension on an instrument, wherein vibratory frequencies are directly related to the mass, length, and tension of the string. The frequency, or rate of vibration of a picket, therefore, could be considered by the following equation:

$$f = \frac{n \sqrt{\frac{T}{m / L}}}{2 L}$$

wherein T is the tension (or stiffness), m is the total mass, and L is the length. Therefore, as accomplished by the present device, and unlike any previously presented device, frequency, or rate of vibration of a picket is effectively decreased by increasing the tension or stiffness of the picket.

Prototype testing has confirmed the effectiveness of the apparatus 10, wherein a DATASTICK VSA-1215 Vibration Spectrum Analyzer was utilized to collect, analyze, and compare data from a railing before and after installation of the presently described preferred anti-vibratory apparatus 10 during a free vibration experiment, utilizing a controlled system to set off the vibration with a reproducible initial energy input. In the testing, a standard length section of an exemplary aluminum railing with a 42″ height was secured at one end of the handrail, to simulate, for example, a corner. The second end of the handrail remained unconnected, such that measurable vibration of the test railing was potentially greater than that of a typical railing installation with both ends connected. A weighted ballast comprising a ten (10) pound sandbag was suspended from an overhead height of 96″, hanging 12″ above ground level when at rest. To deliver a force to initiate the test vibration, the ballast was positioned 52″ from the railing and released to strike the aluminum railing.

Data collection clamps were connected to a picket. Assessment of vibration involved measurement of vibration acceleration and vibration decibels before and after installation of anti-vibratory apparatus 10. Graphical results in FIG. 5 display acceleration measurement results, with waveforms measured before installation of apparatus 10. Overall acceleration reported at 1.158 g, with peaking values (vibration impact energy) initially measured at 0.0289 g.

After installation of apparatus 10, overall acceleration was 0.6238 g, and peaking values measured at 0.00747 g. Thus, acceleration realized a decrease of approximately 50% and peaking value almost 75%. Even without the calculations, a quick visual comparison of the waveforms on equal scales, before and after installation of apparatus 10, FIGS. 5 and 6, respectively, confirms the significance of the impact thereof.

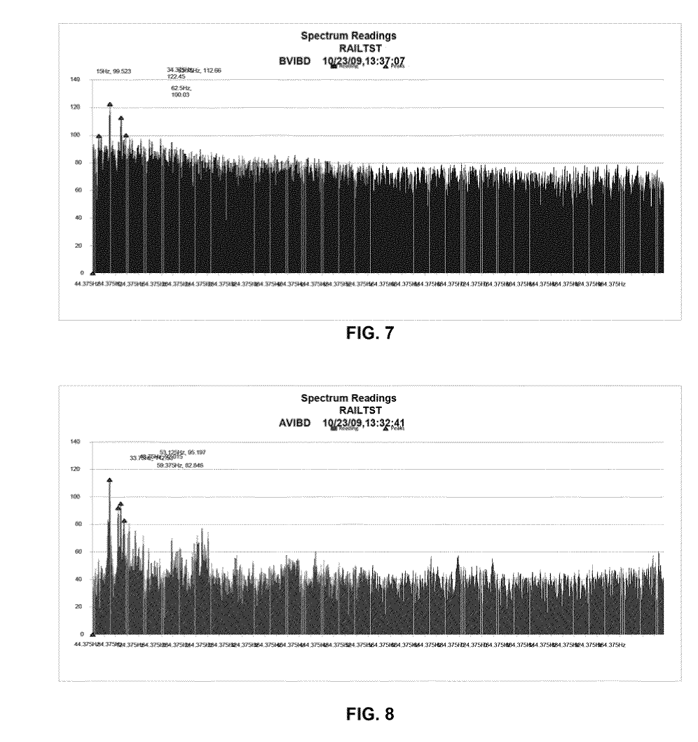

Further comparative measurements were collected, measuring vibratory decibels. First, as seen in FIG. 7, for the railing without apparatus 10 installed, the overall vibration decibel was reported as 2987.

After installation of apparatus 10, overall vibration decibel was 1736, again approximately a 50% reduction. As with the acceleration readings, graphical representation in FIGS. 7 and 8 of the decibel results on equal scales clearly display the effective impact of apparatus 10, essentially cutting the decibel level in half.

Anti-vibratory apparatus 10 thus functions to tensively impact each picket, accomplishing the desired effect without impacting the structural integrity of the picket, and thus without introducing a potential weak point for subsequent corrosion or failure. Anti-vibratory apparatus 10 also functions to tensively impact each picket with only minimal impact on the visual aesthetics of the railing structure. The preferred combination of elements, cable 20, plurality of attachment components 40, and plurality of tension applicators 60, provides this beneficial functionality, and also allow for quick and easy installation with tension tool 80.

As may be representatively viewed in FIGS. 1-4B, each preferred attachment component 40 is generally formed as bracket 42, comprising picket engagement portion 44, cable receptacle 46, and tension-adjustment port 48. Preferably, picket engagement portion 44 is adapted for frictional engagement about a portion of the diameter of a picket P, wherein picket P is typically of a cylindrical configuration, and picket engagement portion 44 is correspondingly “C”-shaped, with engagement arms 50a and 50b extending, in curvilinear fashion, from body 52. It should be noted that picket engagement portion 44 of bracket 42 could be otherwise configured in order to accommodate other picket shapes and/or styles, such as, for example, pickets having triangular, square, or rectangular cross-sections, or essentially any shape, wherein ¾″ aluminum square pickets are routinely encountered.

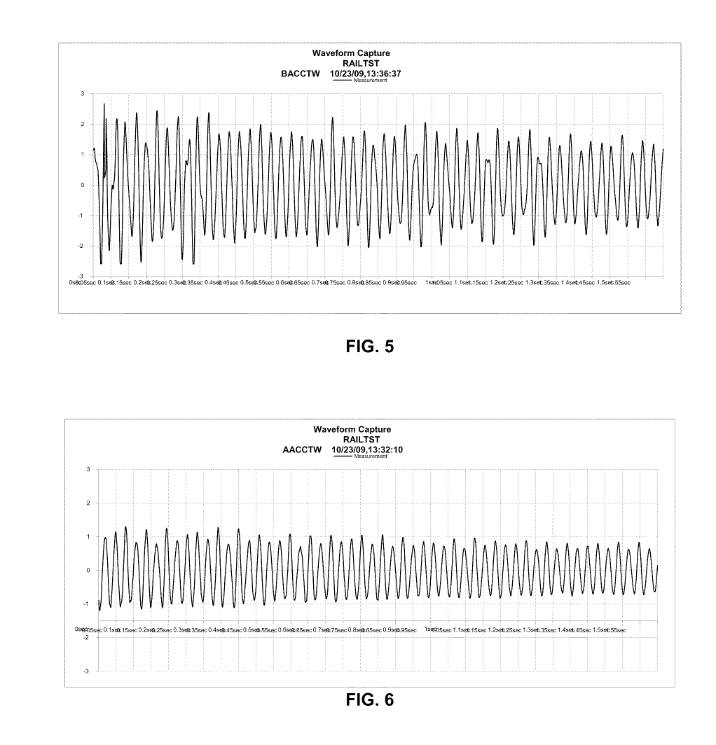

Therefore, by way of specific example, yet without limitation, one exemplary alternate embodiment may be representatively viewed in FIG. 4C, wherein such embodiment is adapted for installation on square pickets. As with the preferred embodiment, attachment component 140 is generally formed as bracket 142, comprising picket engagement portion 144, cable receptacle 146, and tension-adjustment port 148. Also similarly, picket engagement portion 144 is adapted for frictional engagement about a portion of the outer surface a picket P, but is particularly useful wherein picket P is of a square cross-sectional configuration, wherein alternate picket engagement portion 144 is correspondingly square-shaped, with engagement arms 150a and 150b extending, essentially straight, from body 152.

It should further be noted that although it is preferred that bracket 42 is formed from non-corroding materials, such as, for example, from PVC, molded polymer, or plastic resins, any suitable material may be utilized, including steel, aluminum, wood, and/or any combination or composite of natural and/or manmade materials, coated and non-coated. According to the preferred configuration, picket engagement portion 44 of bracket 42 has some measure of elasticity or resilience, in order to enable frictionally fitted installation about picket P. However, bracket 42 could be adapted with an alternate picket engagement portion, as discussed hereinbelow, without departing from the intended scope of the present disclosure.

Opposingly positioned relative to picket engagement portion 44 of bracket 42 is tension-adjustment port 48, preferably defined as a generally cylindrical and threaded cavity within body 52. Cable receptacle 46 is also preferably defined within body 52 as a tunnel extending from first side 54a to second side 54b of body 52. According to the preferred embodiment, cable receptacle 46 is positioned at a right angle relative to tension-adjustment port 48, with tension-adjustment port 48 centered along the length of cable receptacle 46. Other configurations may be possible, wherein the equivalent functionality may be achieved, and should be considered to be within the scope of the present disclosure.

Cable receptacle 46 is dimensioned to allow for slidable insertion of cable 20 therethrough, wherein cable 20 may be an appropriate gauge wire, an insulated or non-insulated cable, steel, or other appropriately strong material capable of delivering and maintaining tension. Cable receptacle 46, therefore, may be formed of any suitable diameter to accommodate cable 20. The diameter of tension-adjustment port 48, however, is related to that of tension applicator 60. That is, preferably tension applicator 60 is socket cap screw 62, wherein tension tool 80 may be utilized for tightening and adjustment of tension applicator 60 into tension-adjustment port 48. It should be apparent to one skilled in the art that any suitable hardware may be utilized for tension applicator 60, as long as delivery of tension to cable 20 may be realized therefrom.

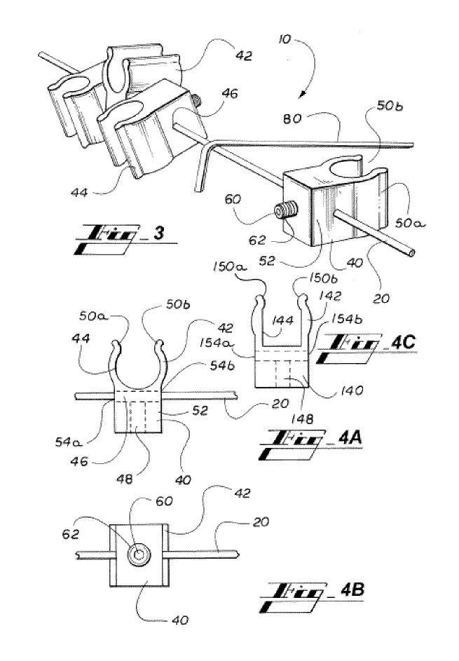

According to the preferred method for preventing audible vibration of a high rise railing, plurality of brackets 42 are slidably installed along a length of cable 20, with cable 20 extending through cable receptacle 46 of each bracket 42, wherein the length of cable 20 and the total number of brackets 42 is selected according to the number of pickets P in a railing section. One of a plurality of tension applicators 60 is inserted into each tension-adjustment port 48 of each bracket 42, and preferred anti-vibratory apparatus 10 is completely assembled for installation, as depicted in FIG. 3. For installation, a first bracket 42 is fit into place, preferably approximately midway along the height of the first internal picket P adjacent a baluster. Thereafter, a second bracket 42 is similarly positioned on the second internal picket P, and so on, until each picket P in series is adapted with a bracket 42, and ending at the last internal picket P adjacent the opposing baluster of the railing segment. Finally, the tension of cable 20 spanning across the pickets P is selectively adjusted via rotation of each tension applicator 60 in each bracket 42. In such manner, picket vibrations are immediately impacted. Additionally, should environmental factors or structural changes impact the railing, or should installed railing positioning necessitate the delivery of different tensions amongst one or more pickets P of a railing segment, further and selective tension adjustment may be accomplished in order to maximize and maintain the effectiveness of anti-vibratory apparatus 10.

According to an alternate embodiment, attachment to pickets may be accomplished via other means besides frictional. For example, a collar or ring member could be fitted around each picket during initial construction of the railing, wherein a screw or other attachment means could secure a bracket body element thereto. Similarly, an openable collar could be retrofit around each picket, wherein a screw or other attachment means could serve to secure the collar about the picket as well as to a bracket body. Additionally, although not preferred, an alternate configuration could involve direct insertion of a tap screw into each picket. According to yet another embodiment, specialized pickets could be formed with integrally related bracket-like extensions, and thus allow for assembly of railings ready to receive a tensile cable thereacross.

According to a further embodiment, each bracket 40 could be colorized, or adapted with a faux finish, such as marble, stone, brass, or any other desirable decorative finish. Also, or alternately, each bracket 40 could have a decorative pattern stamped or otherwise imparted on end surface 70, and/or a decorative cap or finial cover could be fashioned to clip, snap, or otherwise fasten thereupon. In still another alternate embodiment, lighted display elements could be integrated into plurality of brackets 40.

Having thus described exemplary embodiments of the present apparatus and method, it should be noted by those skilled in the art that the within disclosures are exemplary only, and that various other alternatives, adaptations, and modifications may be made within the scope of the present disclosure. Accordingly, the present disclosure is not limited to the specific embodiments illustrated herein, but is limited only by the following claims.

I claim:

1. An apparatus for reducing vibration of railing pickets, comprising:
a wire, and
a plurality of support members positioned along said wire,
wherein each said support member is adapted for frictional engagement with a picket, and
wherein each said support member is adapted for tensioned adjustment of said wire relative thereto.

2. A tension-delivery apparatus for use with a picket-style railing, comprising:
a cable,
a plurality of brackets, and
a plurality of tension applicators,
wherein said plurality of tension applicators are carried by said plurality of brackets,
wherein said plurality of brackets are installed proximate a plurality of pickets, and
wherein said plurality of tension applicators deliver tension to said cable.

3. The tension-delivery apparatus of claim 2, wherein each said bracket of said plurality of brackets is adapted for frictional engagement about a portion of an outer surface of a picket.

4. The tension-delivery apparatus of claim 2, wherein each said bracket of said plurality of brackets further comprises a throughhole, said throughhole dimensioned to receive said cable therethrough.

5. The tension-delivery apparatus of claim 2, wherein each said bracket of said plurality of brackets further comprises a port, said port dimensioned to one of said plurality of tension applicators therein.

6. The tension-delivery apparatus of claim 2, wherein each said bracket of said plurality of brackets further comprises a picket engagement portion, a cable receptacle, a tension-adjustment port, and a body.

7. The tension-delivery apparatus of claim 6, wherein said picket engagement portion of said bracket is C-shaped.

8. The tension-delivery apparatus of claim 2, wherein said plurality of brackets are formed from material selected from the group consisting of non-corroding materials, PVC, molded polymer, plastic resins, steel, aluminum, wood, natural material, and manmade materials, coated and non-coated.

9. The tension-delivery apparatus of claim 6, wherein said picket engagement portion of said plurality of brackets has at least some elasticity and resilience.

10. The tension-delivery apparatus of claim 6, wherein said tension-adjustment port is preferably a generally cylindrical and threaded cavity within said body.

11. The tension-delivery apparatus of claim 2, wherein said cable is selected from the group consisting of an appropriate gauge wire, an insulated cable, a non-insulated cable, and steel.

12. The tension-delivery apparatus of claim 2, wherein said plurality of tension applicators are socket cap screws.

13. The tension-delivery apparatus of claim 2, wherein each of said plurality of brackets further comprise a collar adapted for fit around a picket.

14. The tension-delivery apparatus of claim 2, wherein each of said plurality of brackets is fastened to a picket by a tap screw.

15. The tension-delivery apparatus of claim 2, wherein each of said plurality of brackets is integrally formed with a picket.

16. The tension-delivery apparatus of claim 2, wherein each of said plurality of brackets carries a decorative finish.

17. The tension-delivery apparatus of claim 2, further comprising a plurality of decorative caps, each said decorative cap carried by one of said plurality of brackets.

18. The tension-delivery apparatus of claim 2, further comprising lighted display elements.

19. The tension-delivery apparatus of claim 6, wherein said picket engagement portion of said bracket is square-shaped.

20. A method of reducing vibration of pickets in a railing, comprising the steps of:
obtaining a cable, a plurality of brackets, a plurality of tension-delivery members, and a tension adjustment tool;
mounting said plurality of brackets on said cable;
inserting one of said plurality of tension-delivery members into each one of said plurality of brackets;
placing one of said plurality of brackets onto a picket;
utilizing said tension adjustment tool to adjust said plurality of tension-delivery members, and thereby to direct tension of said cable spanning across the pickets, tensively impacting each picket.
